(19) United States
(12) Patent Application Publication
(10) Pub. No.: US 2023/0086583 A1
(43) Pub. Date: Mar. 23, 2023

(54) STORAGE SYSTEM HAVING TWO TRANSFER POSITIONS ORIENTED OBLIQUELY TO EACH OTHER

(71) Applicant: KARDEX PRODUKTION DEUTSCHLAND GMBH, Neuburg/Kammel (DE)

(72) Inventors: Harald Preschke, Vohringen (DE); Wolfgang Kollmann, Pfaffenhausen (DE)

(21) Appl. No.: 17/904,047

(22) PCT Filed: Mar. 5, 2021
(86) PCT No.: PCT/EP2021/055625

§ 371 Date: Aug. 11, 2022

(30) Foreign Application Priority Data
Mar. 6, 2020 (DE) 10 2020 202 912.1

(51) Int. Cl. B65G 1/04

(52) U.S. Cl. CPC B65G 1/0407; B65G 1/0485

(57) ABSTRACT

Storage system having two transfer positions oriented obliquely to each other The invention relates to an automatic storage system (1) and a method for automatically depositing and/or retrieving storage-goods carriers (4). It is the aim of the invention to provide a storage system (1) and a method that permit a quick deposition and retrieval while requiring little space. This is achieved in a storage system (1) having a storage region (2), including a storage aisle (12) and storage spaces (6) for the storage-goods carriers (4) adjoining the storage aisle, by a conveying device (16) which is designed to be movable into two adjacent transfer positions (14, 15) oriented obliquely to each other in order to deposit a storage-goods carrier (4) into the storage region (2) and/or to retrieve a storage-goods carrier (4). Preferably, the storage-goods carrier can move from above or below the one transfer position (14, 15) by a mere pivotal movement to below or above the other transfer position (15, 14).

The invention relates to an automatic storage system and a method for automatically depositing and/or retrieving storage-goods carriers.

Automatic storage systems, for example in the form of storage lifts, are known. In a storage lift, a conveying device reciprocates in a storage aisle limited by storage shelves vertically, and in some embodiments also horizontally. The storage shelves include storage spaces for storage-goods carriers. The conveying device is used for depositing and retrieving the storage-goods carriers into or out of the storage spaces, respectively.

Such storage systems are often part of an automatic picking device in which the storage-goods carriers with the storage goods to be picked are, for depositing, automatically approached to the storage lift, transferred to the conveying device of the storage lift at a transfer position, and moved to a storage space in the storage region by the conveying device, or transported to the transfer position by the conveying device for retrieval and from there automatically moved away.

The deposition and retrieval in a storage system should work preferably quickly in such storage systems to ensure a high throughput. Moreover, a compact design should be achieved so that as many storage systems and transport systems connecting these storage systems as possible can be installed in a predetermined space.

It is therefore an object of the present invention to improve an automatic storage system and a method for automatically depositing and/or retrieving storage-goods carriers in such a way that the depositing and retrieving processes are accelerated while requiring little space.

This object is achieved according to the invention on the one hand by an automatic storage system with a storage region including a storage aisle and storage spaces adjoining the storage aisle for one storage-goods carrier each, having a conveying device movable in the storage aisle and having two transfer positions located one next to the other on one side of the storage region and being oriented obliquely to each other, wherein the conveying device is designed to be movable to the transfer positions to deposit a storage-goods carrier into the storage region and/or to retrieve a storage-goods carrier.

On the other hand, this object is achieved by a method for automatically depositing and/or retrieving storage-goods carriers, wherein the storage-goods carriers are moved, by a conveying device, in particular individually between a storage region in which the storage-goods carriers are deposited and one of two transfer positions adjoining on one side of the storage region and oriented obliquely to each other, wherein the storage-goods carrier are discharged to outside the storage region at the transfer positions by the conveying device for further treatment, or are received from outside the storage region.

Thanks to the transfer positions which are oriented obliquely to each other or offset to each other, only little space is required. The adjoining oblique arrangement permits a swift change of the conveying device between the two transfer positions which accelerates the deposition and retrieval since a storage-goods carrier can be swiftly discharged at the one transfer position and received at the other transfer position.

For the sake of simplicity, the transfer position designates both a spatial position of a storage-goods carrier or a position that can be taken by a storage-goods carrier, and the spatial position of the conveying device corresponding to this spatial position since the difference between the spatial positions is not relevant. The transfer position of the conveying device here designates the spatial position the conveying device assumes when the storage-goods container transported by it or to be transported by it is in the transfer position.

The solution according to the invention can be further improved by the following developments which can be combined with each other in any way and are advantageous each taken for themselves.

For example, the storage-goods carrier can in particular be a standardized small load carrier, for example a Euro container. The standardized design of the storage-goods carrier facilitates its handling across very diverse systems.

In a storage-goods carrier, similar or different storage goods can be received. Preferably, the storage-goods carriers are individually handled by the automatic storage system, that means the device is preferably designed to receive and transport or deposit or retrieve storage-goods carriers each individually.

The storage spaces can be located in storage shelves. In the storage shelves, the storage spaces for the storage-goods carriers can be arranged one upon and/or next to each other. The storage spaces can all have the same or different sizes. In two opposed storage shelves, the storage aisle can be arranged between the two storage shelves. The conveying device can be movable along the storage aisle in a horizontal and/or vertical direction.

According to a further advantageous embodiment, the conveying device can be pivoting about a pivoting axis that in particular extends vertically. The pivoting axis can be movable horizontally. The conveying device can be designed to perform a pivotal movement in the storage aisle and/or between the transfer positions. A pivoting conveying device permits a structure of the storage system in which a transfer of storage-goods carriers can be accomplished not only in the extension of the storage aisle, but also at any point transverse to the storage aisle.

In the one transfer position, the conveying device is preferably pivoted, in particular about the pivoting axis, with respect to the other transfer position. By the pivoting, the conveying device can travel to an obliquely oriented transfer position.

According to a further advantageous embodiment, the conveying device can have a gripper which is extendable and/or retractable in particular with respect to the rest of the conveying device. The gripper can be designed, for example, for placing a storage-goods carrier on it. In such a case, the gripper is, for example, a simple platform on which a preferably individual storage-goods carrier rests. If standardized storage-goods carriers are used, interlocking elements of the story-goods carrier and the gripper can engage with each other to prevent a shifting of the storage-goods carrier on the support.

A transfer position can be located, at least in sections, outside the storage region or outside the storage aisle. In such a case, it makes sense for the gripper to be at least partially extended in the transfer position. In such an embodiment, the remaining conveying device can remain in the storage region, and a conveyance beyond the storage region is permitted by the extendability of the gripper.

The conveying device can be retained at a mast in a moving manner, the mast being designed to be movable along the storage aisle.

According to a further advantageous embodiment, the transfer positions are arranged, at least in sections, in extension to the storage aisle, that means at a front face of the storage aisle. The advantage of this is that the transfer position is located at the position of a storage opening which is common for storage systems, in particular in storage lifts. Moreover, in this embodiment, in particular in case of a storage lift, no storage spaces have to be abandoned to provide the transfer position since at the front end of the storage aisle, often no storage spaces are provided. Finally, an advantage of this embodiment is that a plurality of storage systems can be erected directly adjoining each other.

The transfer positions can also be located, at least in sections, in extension of a lateral storage opening of the storage region which is parallel to the storage aisle. The lateral storage opening can be formed in a side wall of the storage system and extend, for example, through a storage shelf towards the storage aisle. The lateral storage opening extends, for example, in parallel to the vertical mid-plane of the storage aisle.

A lateral storage opening can be advantageous for the material flow in certain configurations, for example, if simultaneously with an automatic deposition or retrieval, a manual access to the storage-goods carrier in the extension of the storage aisle, at the front face of the storage aisle, is to be possible.

The storage system can include an enclosure surrounding the storage region in which the storage opening is formed at the front side or laterally. The conveying device extends through the storage opening when it is in a transfer position. The transfer positions can be located completely beyond the storage opening, seen from the storage region. However, the transfer positions can also extend partially through the storage opening into the storage region.

The transfer positions can be rotated or offset with respect to each other about an axis of rotation in particular extending vertically. This embodiment permits the conveying device to perform a pivotal movement in the movement from the one to the other transfer position. Such a pivotal movement can be constructively easily realized and can be constructively easily and precisely realized.

In this context, it is particularly advantageous for the axis of rotation about which the two transfer positions are rotated relatively with respect to each other to extend coaxially to the pivoting axis of the conveying device located in one of the transfer positions. Thereby, the conveying device can travel to the angular positions corresponding to the two transfer positions by a mere pivotal movement. A deviation of the axis of rotation from the pivoting axis in view of coaxiality and/or parallelism of less than 5° to 10° is still to be considered as coaxial. The angle between the two transfer positions is, for example, between 20° and 80°, preferably between about 30° and about 60°.

The two transfer positions can be spaced apart at any point so that one storage-goods carrier can be located simultaneously in both transfer positions. The two transfer positions, however, can also cover or overlap each other in sections permitting a more compact design. Then, however alternately, only one storage-goods carrier at a time can be located in one transfer position.

For the conveying device not having to perform any unnecessary vertical movements in the transition from the one transfer position to the other, the transfer positions can be located at the same level, that means in the same horizontal plane.

The transfer positions can be oriented obliquely to the storage opening. In this manner, a V-shaped arrangement of the transfer positions can result. The orientation of a transfer position is determined by the orientation of at least one vertical mid-plane of the storage-goods carrier.

Preferably, the transfer positions are arranged obliquely to a mid-plane of the storage opening extending perpendicularly to the storage opening and vertically, in particular symmetrically. The mid-plane of the storage opening can here correspond to a mid-plane of the storage aisle. In a transfer position, the pivoting axis of the conveying device can be located in the mid-plane of the storage aisle. A deviation of the position within the tolerance measures common in storage systems is still considered as lying on the mid-plane.

Preferably, the two transfer positions are arranged symmetrically to a vertical mid-plane extending perpendicularly to the storage opening. This has the advantage that the conveying device can reach, starting from a mid-position, both transfer positions within the same period, that means that no transfer position is preferred.

According to a further advantageous embodiment, the conveying device, in particular the gripper, can be designed to be movable up and down from at least one and/or into at least one of the transfer positions. So, if the conveying device is in a transfer position, it can be moved from there to the top and/or to the bottom, that means vertically. This permits the conveying device to receive, in a movement from below the transfer position, through the transfer position to above the transfer position, a storage-goods carrier located in the transfer position. In a movement of the conveying device with a storage-goods carrier located on the conveying device, by a travel of the conveying device from above the transfer position through the transfer position to below the transfer position, a placing of the storage-goods carrier at the transfer position is permitted.

The conveying device can be designed to be pivoting from the one transfer position directly into the other transfer position. In particular, the conveying device can be designed to be pivoting from a position directly above the one transfer position directly into a position above the other transfer position without any translatory movement having to be performed in-between. As an alternative or in addition, the conveying device can be designed to be pivoting from a position directly below the one transfer position preferably directly, in particular without any translatory movement in-between, directly into a position below the other transfer position. For the conveying device to be able to perform such a swift and direct pivotal movement, the space above and/or below the transfer position and/or between the two transfer positions should be unobstructed so that the gripper does not have to be retracted during the pivotal movement and/or the conveying device does not have to be returned.

Advantageously, at each transfer position, there is a storage-goods carrier seat where a preferably individual storage-goods carrier can be placed. Such a storage-goods carrier seat can be designed, for example, as a table, so that a storage-goods carrier can be manually handled at the seat. In this manner, individual storage goods can be withdrawn from a storage-goods carrier by a user, for example a picker and/or a robot (SFS), or be placed into a storage-goods carrier.

The transfer positions and thus the seats, however, can also be each defined as sections of two different transport paths for storage-goods carriers. In particular, the seats can be designed as an end or a beginning of one transport path each. Via a transport path, a storage-goods carrier can be transported from or into a transfer position. In one advantageous embodiment, always the same transfer position can be designed or utilized for the retrieval of a storage-goods carrier and thus for its removal, and always the respective other transfer position can be exclusively designed or utilized for the deposition and thus the transport of an individual storage-goods carrier.

The conveying device is designed, according to a further embodiment, to discharge individually to one storage-goods carrier of each seat, in particular to place, and/or to pick up, in particular lift, from each seat individually.

The position and orientation of the seats is consistent with the position and orientation of the corresponding transfer positions. For example, the seats can be located at least partially or completely outside the storage region. The seats can be arranged in a V-shape.

The conveying device can be embodied to move, starting from a transfer position, above and/or below the seat corresponding to this transfer position. Furthermore, the conveying device can be designed to rotate from the one to the other seat in particular above and/or below the same. The seats can be arranged one next to the other and at the same level. The seats can be arranged obliquely to each other and obliquely to a vertical mid-plane of the storage opening and/or the storage aisle, in particular symmetrically to the mid-plane.

The seats can each have a pass-through in the form of a horizontal opening which is open towards the storage region. The pass-through is dimensioned such that the conveying device, in particular the gripper, can travel through the pass-through in a vertical direction. Simultaneously, the pass-through is smaller than a base of a storage-goods carrier, so that a storage-goods carrier can be placed onto the seat despite the pass-through and cannot fall through.

A distance between the two transport paths can increase in the direction away from the transfer positions. The region where the distance between the two transport paths increases in the direction away from the transfer positions can be located between the storage region and a section of the transport paths in which the transport paths extend in parallel to each other. The transport paths can extend in a curved manner away from the transfer positions at least in sections, for example, in the region where the distance between the transport paths increases.

In the automatic method for the deposition and/or retrieval, the conveying device can accept a storage-goods carrier at one of the transfer positions for deposition and transfer another storage-goods carrier to the other transfer position for retrieval. This permits swift changes between the deposition and retrieval.

In particular, the conveying device can discharge a storage-goods carrier at a transfer position and directly subsequently, in particular without returning to the storage region or the storage aisle, pick up another storage-goods carrier at the other transfer position.

Before the transfer position is reached, the storage-goods carrier is pivoted by the conveying device according to one embodiment. Pivoting can be already accomplished in the storage aisle or only after leaving the storage aisle, for example in the storage opening. Pivoting can be accomplished, for example, after a removal of the storage-goods carrier from the storage space, with an otherwise resting conveying device, or during a horizontal and/or vertical drive of the conveying device through the storage aisle.

Below, the invention will be illustrated by way of example by means of an embodiment with reference to the enclosed figures. In accordance with the above illustrations, individual features whose technical effect is not important in a certain application, can be omitted. In an embodiment described below, individual features can also be added in accordance with the above illustrations if the technical effect of these features is not important in a certain application.

In the following description and the enclosed figures, for elements that correspond to each other in view of their functions and/or structures, the same reference numerals are used.

In the drawing:

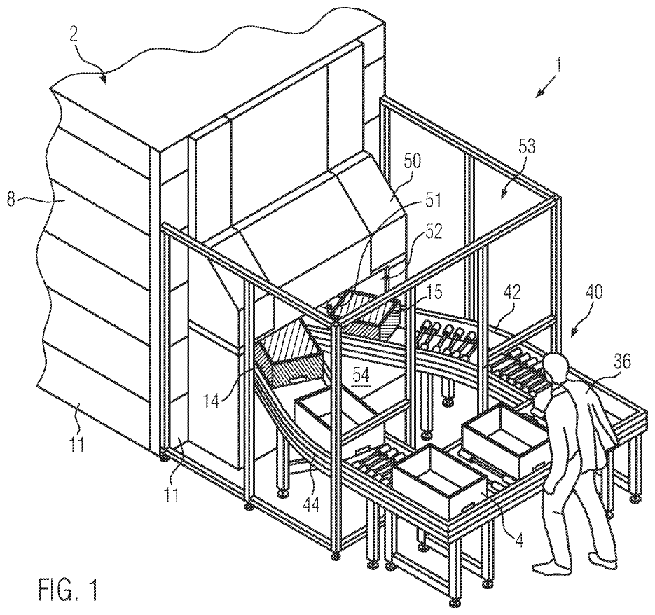

FIG. 1 shows a schematic perspective view of a storage system;

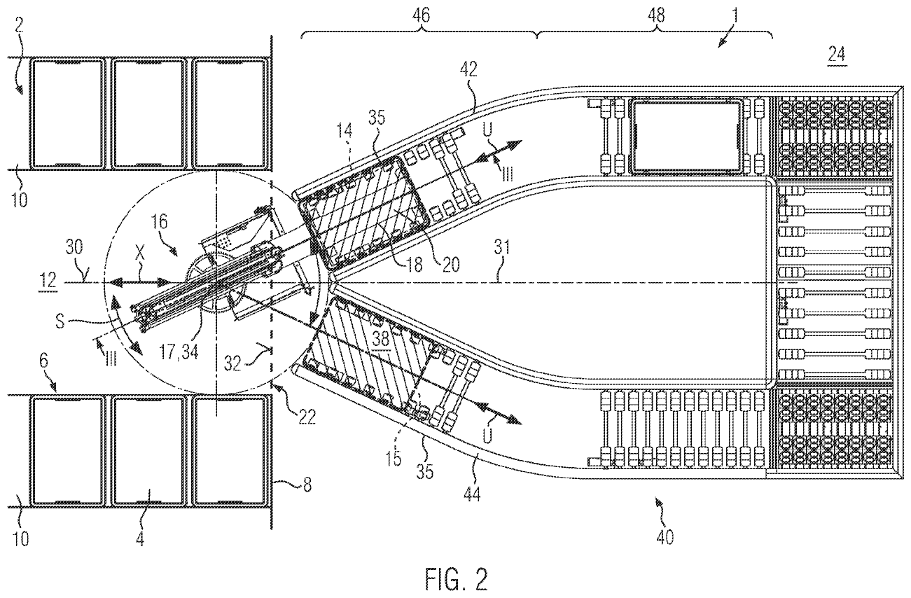

FIG. 2 shows a schematic plan view onto a part of the storage system of FIG. 1;

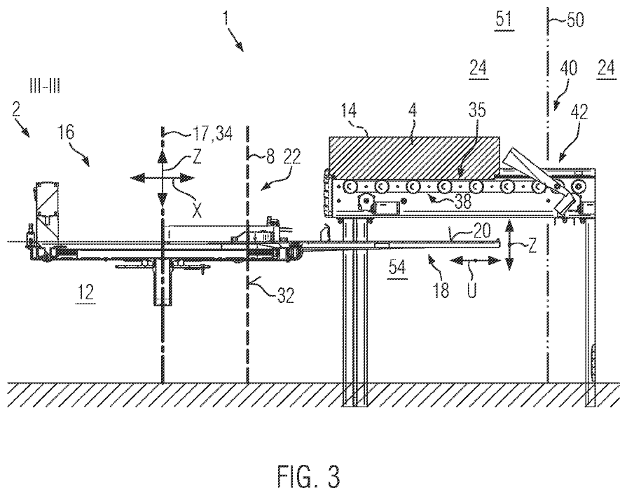

FIG. 3 shows a schematic side view of a part of the storage system of FIG. 1 in a view III-III of FIG. 2;

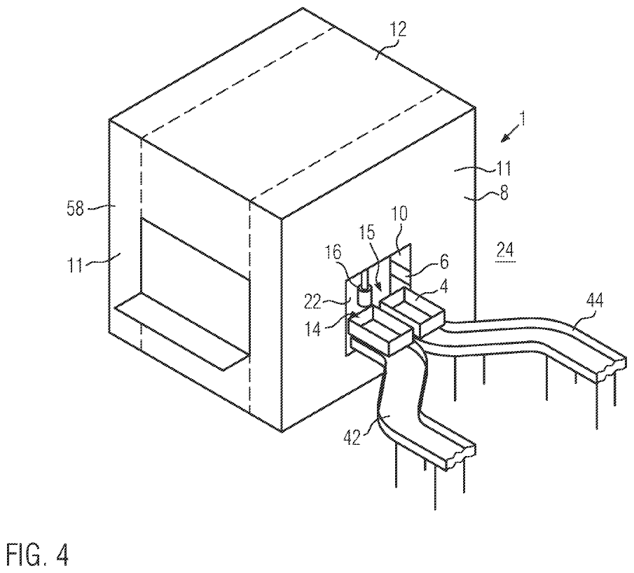

FIG. 4 shows a schematic perspective view of a further storage system.

First, the structure of a storage system 1 is illustrated with reference to FIGS. 1 to 3. In FIGS. 2 and 3, individual parts of FIG. 1 are omitted to give a better overview.

The storage system 1 has a storage region 2 in which storage-goods carriers 4 are stored. The storage-goods carriers 4 are, for example, trays on which storage goods can be placed, and/or in particular standardized small load carriers, such as Euro boxes. The storage-goods carriers 4 are preferably individually stored in the storage region 2. One storage space 6 is associated with each storage-goods carrier 4. The storage space management can be dynamic so that one respectively free storage space 6 is associated with each storage-goods carrier 4 in the deposition process.

The storage region 2 can be surrounded by an enclosure 8. The storage region 2 can furthermore have at least two opposed storage shelves 10 between which a storage aisle 12 is provided. In a storage shelf 10, the storage spaces 6 are arranged above and below each other to be accessible from the storage aisle 12.

The storage system 1 has, on one side 11 of the storage aisle 12, two transfer positions 14, 15 where one storage-goods carrier 4 each is transferred from the storage region 2 by a conveying device 16 and is discharged for further treatment or accepted for depositing it from outside the storage region 2. The side 11 can be a front side or a side face. In FIGS. 1 to 3, the transfer positions are located at the front side of the storage aisle only by way of example.

The conveying device 16 is movable in the storage aisle 12 and to a transfer position. It transfers a storage-goods carrier, in particular one individual storage-goods carrier each, from the transfer positions 14, 15 into a storage space 6, or from a storage space 6 into one of the two transfer positions 14, 15. The conveying device 16 is furthermore designed to directly move from one transfer position 14, 15 to the other transfer position 15, 14.

As is shown in FIG. 2, the transfer positions 14, 15 can be located at least in sections in extension of the storage aisle 12.

The conveying device 16 is linearly movable along the storage aisle 12 in a horizontal direction X. Furthermore, the conveying device 16 is movable in a vertical direction Z. Moreover, the conveying device 16 is pivoting about a vertical pivoting axis 17.

The conveying device 16 can have a gripper 18 which is designed to pick up a storage-goods carrier 4. The gripper 18 can include, for example, a support 20 on which a storage-goods carrier 4 can be placed during transport. On the support 20, a storage-goods carrier 4 can be secured against slipping by positive engagement. The gripper 18 or the support 20 can each be moved to the transfer positions 14, 15 of the storage-goods carriers 4.

The gripper 18 is designed to be retractable and extendable in particular in a horizontal direction U, so that the distance of the support 20, for example from the vertical pivoting axis 17 of the conveying device 16, is variable. By the pivotal movement 8 about the pivoting axis 17, the direction U changes. However, it remains horizontal. In the transfer position 14, 15, the gripper 18 is preferably extended.

The conveying device 16 extends through a storage opening 22 in the enclosure 8 when it is in a transfer position 14, 15. The storage-goods carriers 4 are conveyed through the storage opening 22 by the conveying device 16 for deposition and retrieval. It connects the storage region 2 with an external surrounding 24 of the storage region 2. With a correspondingly large enclosure 8, the transfer positions 14, 15 can, of course, also be located completely within the enclosure.

The transfer positions 14, 15 are located one next to the other, preferably at the same level. They are arranged flush with the storage aisle 12 at least partially, that means they are located in an imaginary extension of the storage aisle at least in sections. The one transfer position 14, 15 is oriented obliquely to the other transfer position 14, 15. A storage-goods carrier 4 which is in a transfer position 14, 15 is accordingly oriented obliquely to a storage-goods carrier 4 which is or would be located in the other transfer position 15, 14.

The transfer positions, 14, 15 can be completely spaced apart from each other, that means they do not overlap, so that two storage-goods carriers 4 at a time can be located therein. In a more compact design, however, the two transfer positions can also partially overlap or cover each other, so that only one storage-goods carrier 4 each can be located in the transfer positions 14, 15.

The transfer positions 14, 15 are preferably arranged symmetrically to each other and symmetrically to an in particular vertical mid-plane 30 of the storage aisle 12. The mid-plane 30 can coincide with the mid-plane of the storage opening 22. The mid-plane 30 is perpendicular to an opening plane 32 spanned by the storage opening 22.

The transfer positions 14, 15 can be rotated about an axis of rotation 34 relative to each other. The pivoting axis 34 here in particular extends in a vertical direction. A horizontal angle between the transfer positions 14, 15 or their vertical mid-planes is between 10° and 80°, preferably between about 30° and about 60°.

If the conveying device 16 is in a transfer position 14, 15, the axis of rotation 17 of the conveying device 16 extends coaxially to the pivoting axis 34. Thus, the conveying device 16 or the gripper 18 only has to be pivoted to move from one transfer position 14, 15 to the other transfer position 15, 14.

The conveying device 16, in particular the gripper 18, can be designed to be movable up and down around the transfer positions 14, 15. By this moveability up and down, it is possible for the gripper 18 to receive, by driving below a transfer position 14, 15 and a subsequent movement vertically to the top beyond the transfer positions 14, 15, a storage-goods carrier 4 provided at this transfer position 14, 15. Vice-versa, the conveying device 16 can place a storage-goods carrier 4 at the transfer position 14, 15 or transfer it to the transfer position 14, 15 by positioning the gripper 18 including the storage-goods carrier 4 above a transfer position 14 and subsequently driving down in the vertical direction.

Depending on the purpose of application and the configuration level of the storage system, different appliances can be provided at the transfer positions 14, 15. For example, in a simple variant, a seat 35 can be simply provided at a transfer position 14, 15.

The seat can have, for example, the shape of a table (not represented), so that one individual storage-goods carrier 4 can be provided at it for further manual treatment. From there, a user 36, for example a picker or a robot (not represented), can pick up the storage-goods carrier 4 and move it to another location, or withdraw storage goods from the storage-goods carrier 4 or place them into the storage-goods carrier 4. Equally, the user 36 can place a storage-goods carrier 4 at the seat 35 for depositing it.

The seat 35 preferably has a horizontal pass-through 38 which is designed such that the conveying device 16 or its gripper 18 can travel through it in the vertical direction Z. The pass-through 38 is smaller than a storage-goods carrier 4, so that a storage-goods carrier can be placed on it without falling through the pass-through 38. The pass-through 38 is open in particular towards the storage region 2, so that the seat 35 is approximately U-shaped.

A different seat 35 is associated with each transfer position 14, 15 and is oriented equally to a storage-goods carrier 4 located in a transfer position 14, 15.

The seats 35 or the transfer positions 14, 15 can be part of one transport system 40 each which can be itself part of the storage system. For example, the seats 35 can be provided with a drive system (not shown) which conveys the storage-goods carriers 4 from the respective transfer position 14, 15 away from the storage region 2. Such a drive system can be, for example, a roller conveyor. As an alternative or in addition, the transport system 40 can move a storage-goods carrier 4 automatically into a transfer position 14, 15, so that it can be there received by the conveying device 16 or the gripper 18, respectively.

The transfer positions 14, 15 can each form one section, in particular a beginning or an end, of one transport path 42, 44 each. The transport paths 42, 44 extend obliquely towards each other in the direction towards the storage region 2 or to the respective transfer position 14, 15, at least in sections. At a predetermined distance from the storage region 2, the transport paths 42, 44 can be oriented parallel with respect to each other. A region 46 of the transport paths 42, 44 in which the transport paths 42, 44 extend obliquely to each other is here located between a region 48 in which the transport paths 42, 44 extend in parallel with respect to each other, and the storage region 2 or the transfer positions 14, 15, respectively. A different transport path 42, 44 can be associated with each seat 35. For example, the transfer position 14 can exclusively or mainly be used for depositing, and the transfer position 15 can be mainly or exclusively used for retrieving storage-goods carriers 4.

The oblique or V-shaped orientation of the transfer positions 14, 15 or the seats 35, respectively, permits the conveying device 16 or the gripper 18 to quickly move from one transfer position 14, 15 to the other transfer position 14, 15 and to thus discharge storage-goods carriers 4 quickly one after the other at a transfer position 14, 15, for example to place them onto a seat 35, and to then subsequently pick up a storage-goods carrier 4 at the other transfer position 14, 15 or the other seat 35 for deposition. Simultaneously, the oblique arrangement only requires little space and permits a better access to the storage system.

The storage system 1 can include a housing 50 that is upstream of the enclosure 8. The housing 50 can project from the enclosure 8 and cover the transfer positions 14, 15, in particular cover the transfer positions 14, 15 at least partly, preferably completely. The transport paths 42, 44 can protrude through an opening 52 of the housing 50 into the region closed by the housing 50. At the side of the region 51 enclosed by the housing 50 facing the storage region 2, the storage opening 22 can be located which connects the storage aisle 12 with the external surroundings 24.

Around the transfer positions 14, 15, in the external region 24, a safety region 53, which is, for example, fenced off, can be established and separate the conveying device 16 or the gripper 18 from an operation region accessible for the user 36.

Below, the function of the storage system 1 and in particular the transfer positions 14, 15 during the deposition and retrieval of storage-goods carriers 4 will be described.

In order to retrieve a storage-goods carrier 4, the conveying device 16 initially moves in the horizontal direction X and the vertical direction Z along the storage aisle 12 to the storage space 6 of this storage-goods carrier. The gripper 18 is here preferably in a retracted position. The gripper 18 then drives below the storage space 6 under the storage-goods carrier 4 in the direction U and subsequently to the top so that it lifts the storage-goods carrier 4 placed on the storage space 6.

Subsequently, the gripper 18 is retracted so that the storage-goods carrier 4 is completely located in the storage aisle 12. The conveying device 16 now drives to a transfer position 14, 15. During this drive, the conveying device 16 or the gripper 18 can be already pivoted to be aligned with a transfer position 14, 15.

At the end of the drive, the gripper 18 is extended until the storage-goods carrier 4 is exactly located above the transfer position 14, 15. Subsequently, the conveying device 16 or the gripper 18 is lowered until the storage-goods carrier 4 is located in the transfer position 14, 15 and is placed on a seat 35 provided there. The gripper 18 here passes through the pass-through 38. The placed storage-goods carrier 4 can now be further treated, for example be transported away by a transport path 42, 44. The gripper 18 is subsequently further lowered and pivoted to the other transfer position 15, 14 below the transfer position 14, 15. For this pivotal movement to be carried out without the gripper 18 having to be retracted, a space 54 below and between the transfer positions 14, 15 is empty. As an alternative or optionally, the gripper 18 can also be pivoted to the respective other transfer position 15, 14 above the transfer positions 14, 15 or above the seat 35, respectively.

The gripper 18 can, in the extended state, be pivoted from the one transfer position 14, 15 into the other transfer position 15, 14 without having to perform a movement in the horizontal direction. As soon as the gripper 18 or the conveying device 16 is located below the other transfer position 15, 14, the gripper 18 can be moved vertically to the top over the other transfer position 15, 14 to accept a storage-goods carrier 4 placed there for depositing it. To place a storage-goods carrier 4 onto a storage space 6, the conveying device 16 then performs the sequence of motions carried out during a retrieval of a storage-goods carrier 4 simply in reverse order.

The oblique offset arrangement of the transfer positions 14, 15 in particular rotated relatively to each other permits a swift movement of the conveying device from the one to the respective other transfer position 14, 15 and thereby a swift switching between deposition and retrieval, and saves space at the same time. By the two transfer positions 14, 15, the waiting time between the removal of a retrieved storage-goods carrier and the arrival of a storage-goods carrier to be deposited is reduced; both can now be simultaneously provided at the transfer positions 14, 15 or, with a slight overlapping of the transfer positions 14, 15, one behind the other in very short intervals.

FIG. 4 shows a storage system 1 wherein the storage opening 22 is located in a side wall 56 and not in a front wall 58 of the enclosure 8 as in FIGS. 1 to 3. At the site of the storage opening 22, a storage shelf 10 can have a recess in the storage region 2.

The transfer positions 14, 15 can in this embodiment be located inside the enclosure 8 or in the storage region 2, for example at the sites where otherwise a storage space 6 or a plurality of storage spaces 6 are located. To withdraw and place a storage-goods carrier at the transfer positions 14, 15, the conveying device 16 or the gripper 18 perform the same movement as in the deposition and retrieval of a storage-goods carrier 4 from a storage space 6. The only difference is that the conveying device is oriented obliquely to a vertical line onto the mid-plane of the bearing axis, since the transfer positions 14, 15 extend obliquely to the storage spaces 6.

Since the transfer positions 14, 15 are located in the storage region 2, the transport paths 42, 44 also project into the storage region or through the storage opening 22.

Non-depicted variations of the represented embodiments are possible.

For example, it is not necessary for a gripper to lift a storage-goods carrier 4 from a storage space 6 or a seat 35 or to place it onto a storage space 6 or a seat 35 by moving up and down. A storage-goods carrier 4 can also be insertable into a storage space 6 or a seat 35. In this case, a gripper 18 does not perform any lowering or lifting movement about a transfer position 14, 15 but is only extended or retracted for discharging or receiving a storage-goods carrier 4.

It is moreover not necessary for the gripper 18 to be extendable if, for example, the storage aisle 12 or the storage shelves 10 have a corresponding design. For example, a storage-goods carrier 4 can be pushed into a transfer position 14, 15 or pulled out of a transfer position 14, 15 by the conveying device 16. To this end, instead of a gripper 18, catches can be driven, for example via a circulating pulling means, which engage with a storage-goods carrier 4. Or else, a belt or roller conveyor can be provided at the conveying device.

### REFERENCE NUMERALS

1 storage system

2 storage region

4 storage-goods carrier

6 storage space

8 enclosure

10 storage shelf

11 side

12 storage aisle

14, 15 transfer position

16 conveying device

17 pivoting axis

18 gripper

20 support

22 storage opening

24 external surroundings of the storage region

30 mid-plane of the storage aisle

31 mid-plane of the storage opening

32 opening plane

34 axis of rotation

35 seat

36 user

38 pass-through

40 transport system

42 transport path

44 transport path

46 obliquely extending region of the transport system

48 region of the transport path extending in parallel

50 housing

51 region enclosed by the housing

52 opening

53 fenced-off safety region

54 space below and between the transfer positions

56 side wall

58 front wall

S pivotal movement

U direction in which the gripper extends and retracts

X horizontal direction along the storage aisle

Z vertical direction

1-15. (canceled)

16. Automatic storage system,
having a storage region including a storage aisle and storage spaces adjoining the storage aisle for one storage-goods carrier each,
having a conveying device movable in the storage aisle,
and having two transfer positions obliquely oriented to each other and located one next to the other on one side of the storage region,
wherein the conveying device is designed to be movable to the transfer positions to deposit a storage-goods carrier into the storage region and/or to retrieve a storage-goods carrier.

17. Automatic storage system according to claim 16, wherein the transfer positions are rotated about an axis of rotation relatively to each other.

18. Automatic storage system according to claim 17, wherein a pivoting axis of the conveying device located in one of the transfer positions extends coaxially with respect to the axis of rotation.

19. Automatic storage system according to claim 16, wherein the transfer positions are arranged obliquely to a storage opening connecting the storage region with an external surrounding of the storage system.

20. Automatic storage system according to claim 19, wherein the two transfer positions are arranged symmetrically to a mid-plane of the storage opening.

21. Automatic storage system according to claim 16, wherein the conveying device is designed to be movable up and down from at least one and/or into at least one of the transfer positions.

22. Automatic storage system according to claim 16, wherein the conveying device is designed to be pivoting from the one transfer position into the other transfer position.

23. Automatic storage system according to claim 16, wherein a storage-goods carrier seat is located at each transfer position.

24. Automatic storage system according to claim 23, wherein at least one of the storage-goods carrier seats is designed as a section of a transport path for storage-goods carriers.

25. Automatic storage system according to claim 16, wherein a space under and/or between the transfer positions is unobstructed.

26. Method for automatically depositing and/or retrieving storage-goods carriers, wherein the storage-goods carriers are moved, by a conveying device, between a storage region in which the storage-goods carriers are deposited, and one of two transfer positions are located one next to the other on one side of the storage region and oriented obliquely to each other, wherein the storage-goods carriers are discharged to outside the storage region at the transfer positions by the conveying device, or are picked up from outside the storage region.

27. Method according to claim 26, wherein the storage-goods carriers are automatically moved to a transfer position and/or away from a transfer position by a transport system located outside the storage region.

28. Method according to claim 26, wherein the conveying device discharges a storage-goods carrier at one of the transfer positions and directly subsequently picks up another storage-goods carrier at another one of the transfer positions.

29. Method according to claim 26, wherein the conveying device performs a pivotal movement from above the one transfer position to above the other transfer position or from below the one transfer position to below the other transfer positions.

30. Method according to claim 26, wherein a storage-goods carrier is pivoted by the conveying device before it reaches the transfer position.
